(19) United States
(12) Patent Application Publication
(10) Pub. No.: US 2026/0121999 A1
(43) Pub. Date: Apr. 30, 2026

(54) NETWORK INTERFACE CARD DEVICE, NETWORK DATA TRANSMISSION METHOD, APPARATUS, AND SYSTEM, DEVICE, AND MEDIUM

(71) Applicant: IEIT SYSTEM (Beijing) Co., Ltd., Beijing (CN)

(72) Inventors: Jiaheng FAN, Beijing (CN); Yanwei WANG, Beijing (CN); Cheng HUANG, Beijing (CN); Junkai LIU, Beijing (CN)

(21) Appl. No.: 19/469,619

(22) PCT Filed: Nov. 28, 2024
(86) PCT No.: PCT/CN2024/135313

§ 371 Date: Sep. 26, 2025

(30) Foreign Application Priority Data
Dec. 22, 2023 (CN) 202311786763.9

(51) Int. Cl. H04L 47/628

(52) U.S. Cl. CPC H04L 47/628

(57) ABSTRACT

Disclosed are a network interface card device, a network data transmission method, apparatus, and system, a device, and a medium, which are applied to the field of Internet technologies. The network interface card device includes a programmable device, which constructs a network platform based on a memory expansion method, and the network platform includes a network interface, a target memory, and a network component. The programmable device is connected to a network through the network interface, and exchanges data with a host by the memory expansion method. The host, based on the memory expansion method, configures the target memory of the programmable device as an extended memory of the host, for storing received target network data belonging to a network interface card processed packet type, or to-be-sent network data of the host.

### CROSS-REFERENCE TO RELATED APPLICATION

This application claims priority of Chinese Patent Application No. 202311786763.9, filed on Dec. 22, 2023 in China National Intellectual Property Administration and entitled “Network Interface Card Device, Network Data Transmission Method, Apparatus, and System, Device, and Medium”, which is incorporated herein by reference in its entirety.

### FIELD

The present application relates to the field of Internet technologies, and in particular, to a network interface card device, a network data transmission method, apparatus, and system, an electronic device, and a non-volatile readable storage medium.

### BACKGROUND

Network data refers to data transmitted over Internet and other network environments, which may be structured and organized data information, unprocessed raw data, or published and received audio and video data.

In a process of transmitting and receiving network data, a related art typically employs a Direct Memory Access (DMA) module of a network interface card device to perform data movement operations. For network data transmission, the DMA module sends data from a host memory to a buffer of a receiving-terminal device. For network data receiving, the DMA module sends data from a buffer of a sending-terminal device to the host memory. However, in certain application scenarios, such as where data does not require host processing, performing network data movement through the DMA module is inefficient, resulting in reduced overall network data transmission efficiency.

### SUMMARY

The present application provides a network interface card device, a network data transmission method, apparatus, and system, an electronic device, and a non-volatile readable storage medium, which may enhance transmission efficiency of network data.

To solve the above problem, the present application provides the following technical solutions.

Some embodiments of the present application provide a network interface card device, including a programmable device, where the programmable device constructs a network platform based on a memory expansion method, and the network platform includes a network interface, a target memory, and a network component.

The programmable device is connected to a network via the network interface and exchanges data with a host by the memory expansion method; the host, based on the memory expansion method, configures the target memory of the programmable device as an extended memory of the host; and the network component transmits data using a data transmission mode that matches a data packet type of to-be-transmitted data.

The to-be-transmitted data is received target network data or to-be-sent network data of the host; the data packet type is determined based on a data type and a data length of the to-be-transmitted data; and the extended memory is configured to store to-be-transmitted data that belongs to a network interface card processed packet type.

In some embodiments, the network component includes a media access control module, a direct memory access module, a buffer, and a packet classifier.

The media access control module is configured to store the target network data received over the network into the buffer and is further configured to send the to-be-sent network data in the buffer over the network.

The packet classifier is configured to identify a data packet type of the target network data and determine a corresponding storage location based on the data packet type of the target network data, and is further configured to store the to-be-sent network data, which is read from the target memory or from a host memory via the direct memory access module, into the buffer, the storage position including the host memory and the target memory.

In some embodiments, a central processing unit of the host accesses the target memory by a memory copy method; and the network interface card processed packet type includes a data packet type having a data length smaller than a length threshold.

If the to-be-transmitted data is the target network data and a data length of the to-be-transmitted data is smaller than the length threshold, the network component stores the to-be-transmitted data into the target memory and sends a packet data read instruction to the host.

If the to-be-transmitted data is the to-be-sent network data and the data length of the to-be-transmitted data is smaller than the length threshold, the host moves the to-be-transmitted data into the target memory by the memory copy method.

In some embodiments, the network component includes a direct memory access module, and a central processing unit of the host accesses the target memory by a direct memory access method; the network interface card processed packet type excludes a data packet type having a data length greater than a length threshold.

If the to-be-transmitted data is the target network data and a data length of the to-be-transmitted data is greater than the length threshold, the network component moves the to-be-transmitted data into a host memory by the direct memory access module; and
if the to-be-transmitted data is the to-be-sent network data and the data length of the to-be-transmitted data is greater than the length threshold, the host stores the to-be-transmitted data into the host memory and sends a packet data read instruction to the network component.

In some embodiments, the programmable device is a field-programmable gate array and constructs the network platform based on a compute express link technology.

The host configures a target memory of the field-programmable gate array as the extended memory by the compute express link technology.

If the to-be-transmitted data is the target network data, the field-programmable gate array identifies the data packet type of the to-be-transmitted data, and if the to-be-transmitted data belongs to a target preset data type and/or the data length of the to-be-transmitted data is smaller than the length threshold, the to-be-transmitted data is stored into the target memory; or if the to-be-transmitted data is the to-be-sent network data, the host identifies the data packet type of the to-be-transmitted data, and if the to-be-transmitted data belongs to a target preset data type and/or the data length of the to-be-transmitted data is smaller than the length threshold, the to-be-transmitted data is stored into the target memory of the field-programmable gate array by the memory copy method.

Some embodiments of the present application provide a network data transmission method, including:
acquiring to-be-transmitted data; and
based on the network interface card device described above, determining a matched data transmission mode according to a data packet type of the to-be-transmitted data, and performing network transmission on the to-be-transmitted data using the data transmission mode.

In some embodiments, the to-be-transmitted data is target network data received over a network, and the network interface card device identifies the data packet type of the to-be-transmitted data; and the determining a matched data transmission mode according to a data packet type of the to-be-transmitted data includes:
if the data packet type of the to-be-transmitted data belongs to a network interface card processed packet type, storing the to-be-transmitted data into a target memory of the network interface card device and sending a packet data read instruction to a host; or
if the data packet type of the to-be-transmitted data belongs to a host processed packet type, storing the to-be-transmitted data into a host memory through a direct memory access module.

In some embodiments, the determining a matched data transmission mode according to a data packet type of the to-be-transmitted data includes:
if a data type of the to-be-transmitted data is a preset data type, determining that the data packet type of the to-be-transmitted data belongs to the network interface card processed packet type, where the preset data type is a data type that is not stored into the host memory; or
if a data length of the data to-be-transmitted data is smaller than a length threshold, determining that the data packet type of the to-be-transmitted data belongs to the network interface card processed packet type.

In some embodiments, the host accesses a target memory by a memory copy method, including:
if the to-be-transmitted data belongs to a first preset data type, the host reads the to-be-transmitted data and directly discards the to-be-transmitted data;
if the to-be-transmitted data belongs to a second preset data type, the host reads the to-be-transmitted data and forwards the to-be-transmitted data; or
if the data length of the to-be-transmitted data is smaller than the length threshold, the host calls a memory copy function to copy the to-be-transmitted data into the host memory, so as to access the target memory by the memory copy method.

In some embodiments, the host accesses the target memory by the memory copy method, including:
if the to-be-transmitted data is cyclic redundancy check data, the host reads the to-be-transmitted data and directly discards the to-be-transmitted data; or
if the to-be-transmitted data is a to-be-forwarded packet, the host reads the to-be-transmitted data and forwards the to-be-transmitted data to a target address.

In some embodiments, before the determining a matched data transmission mode according to a data packet type of the to-be-transmitted data, the method further includes:
transmitting test transmission data of different data lengths by a memory copy method and a direct memory access method respectively, and collecting corresponding transmission times; and
performing comparative analysis on transmission times required for transmitting test transmission data of the same data length by the memory copy method and the direct memory access method, and determining a data length at which the transmission time required by the memory copy method and the transmission time required by the direct memory access method are equal as a length threshold.

In some embodiments, before the determining a matched data transmission mode according to a data packet type of the to-be-transmitted data, the method further includes:
when receiving a length threshold configuration instruction input by a user, parsing the length threshold configuration instruction to obtain a length threshold, and storing the length threshold to a target location.

In some embodiments, the to-be-transmitted data is to-be-sent network data of a host, and the host identifies the data packet type of the to-be-transmitted data; and the determining a matched data transmission mode according to a data packet type of the to-be-transmitted data includes:
if the data packet type of the to-be-transmitted data belongs to a network interface card processed packet type, storing the to-be-transmitted data into a target memory of the network interface card device and sending a packet data read instruction to the network interface card device; or
if the data packet type of the to-be-transmitted data belongs to a host processed packet type, storing the to-be-transmitted data into the host memory and sending a packet data read instruction to the network interface card device.

In some embodiments, the determining a matched data transmission mode according to a data packet type of the to-be-transmitted data includes:
pre-constructing storage data index information in the target memory of the network interface card device, where the storage data index information is configured to record storage location information of received packets and sent packets;
updating the storage data index information based on the data packet type of the to-be-transmitted data; and
determining the data transmission mode corresponding to the to-be-transmitted data according to the storage data index information and sending-terminal information of the to-be-transmitted data.

In some embodiments, the to-be-transmitted data is the target network data, and the determining the data transmission mode corresponding to the to-be-transmitted data according to the storage data index information and sending-terminal information of the to-be-transmitted data includes:
pre-constructing a network interface card packet receiving queue in the target memory of the network interface card device and a host packet receiving queue in the host memory respectively;
pre-pointing queue pointers of receiving producers corresponding to the network interface card packet receiving queue and the host packet receiving queue to corresponding initialization positions respectively, where the receiving producers include a buffer producer and a direct memory access module producer; and
based on a receiving queue of the storage data index information, if the to-be-transmitted data belongs to the network interface card processed packet type, storing the to-be-transmitted data to a pointer position of the buffer producer in the network interface card packet receiving queue and moving a pointer of the buffer producer downward; or if the to-be-transmitted data belongs to the host processed packet type, storing the to-be-transmitted data to a pointer position of the direct memory access module producer in the host packet receiving queue and moving a pointer of the direct memory access module producer downward.

In some embodiments, after the performing network transmission on the to-be-transmitted data using the data transmission mode, the method further includes:
pre-pointing queue pointers of receiving consumers corresponding to the network interface card packet receiving queue and the host packet receiving queue to corresponding initialization positions respectively, where the receiving consumers are packet data reception and transmission threads of the host, and pointer positions of the receiving consumers are behind pointer positions of the receiving producers; and
determining, by the host, a storage location of a storage queue corresponding to the to-be-transmitted data according to the receiving queue, reading the to-be-transmitted data according to the storage location of the to-be-transmitted data, and moving a pointer of the receiving consumer downward.

In some embodiments, the to-be-transmitted data is to-be-sent network data, and the determining the data transmission mode corresponding to the to-be-transmitted data according to the storage data index information and sending-terminal information of the to-be-transmitted data includes:
pre-constructing a network interface card packet sending queue in the target memory of the network interface card device and a host packet sending queue in the host memory respectively;
pre-pointing queue pointers of sending producers corresponding to the network interface card packet receiving queue and the host packet receiving queue to corresponding initialization positions respectively, where the sending producers are packet data reception and transmission threads of the host;
pre-pointing queue pointers of the sending producers corresponding to a sending queue of the storage data index information to corresponding initialization positions, and moving pointer positions of the sending producers downward when updating the sending queue; and
based on the sending queue of the storage data index information, if the to-be-transmitted data belongs to the network interface card processed packet type, storing the to-be-transmitted data into the network interface card packet receiving queue and moving a pointer of the sending producer downward; or if the to-be-transmitted data belongs to the host processed packet type, storing the to-be-transmitted data into the host packet receiving queue and moving a pointer of the sending producer downward.

In some embodiments, after the performing network transmission on the to-be-transmitted data using the data transmission mode, the method further includes:
pre-pointing queue pointers of sending consumers corresponding to the network interface card packet sending queue and the host packet sending queue to corresponding initialization positions, where the sending consumers include a buffer consumer and a direct memory access module consumer, and pointer positions of the sending consumers are behind the pointer positions of the sending producers; and
based on the sending queue of the storage data index information, if to-be-stored data belongs to the network interface card processed packet type, reading the to-be-stored data from the network interface card packet sending queue and moving a pointer of the buffer consumer downward; or if the to-be-stored data belongs to the host processed packet type, reading the to-be-stored data from the host packet sending queue and moving a pointer of the direct memory access module consumer downward.

Some embodiments of the present application provide a network data transmission apparatus, including:
a data acquisition module, configured to acquire to-be-transmitted data; and
a network transmission module, configured to determine, based on the network interface card device described above, a matched data transmission mode according to a data packet type of the to-be-transmitted data, and perform network transmission on the to-be-transmitted data using the data transmission mode.

Some embodiments of the present application further provide an electronic device, including a processor, where the processor is configured to execute a computer program stored in a storage device to implement the steps of the network data transmission method described above.

Some embodiments of the present application further provide a non-volatile readable storage medium, having a computer program stored therein, and the computer program, when executed by a processor, implements the steps of the network data transmission method described above.

Some embodiments of the present application further provide a network data transmission system, including a host, the network interface card device described above, and a processor,
where the processor is configured to execute a computer program stored in a storage device to implement the steps of the network data transmission method described above.

The technical solutions provided in the present application have the advantage that functions of a high-performance network interface card are implemented by means of a programmable device and a memory expansion technology. The host configures, through the memory expansion technology, a memory block in the programmable device as the extended memory accessible by the host. The extended memory may be configured to store network data of a pre-specified packet type, without the need to store all such network data in the host memory. Certain network data that does not require host processing and for which data movement through a direct memory access module is inefficient may be directly stored in the extended memory. That is, an optimal data transmission mode is determined according to the data packet type of the to-be-transmitted data, thereby effectively enhancing the transmission efficiency of network data.

In addition, the present application further provides a corresponding network data transmission method, an implementation apparatus, and system, an electronic device, and a non-volatile readable storage medium for the network interface card device, which further enhance the practicality and feasibility of the network interface card device. The network data transmission method, apparatus, system, electronic device, and non-volatile readable storage medium also have corresponding advantages.

It is to be understood that both the foregoing general description and the following detailed description are exemplary and explanatory only and are not restrictive of the application.

### BRIEF DESCRIPTION OF THE DRAWINGS

In order to describe the technical solutions of the present application or in the related art more clearly, drawings required for the description of the embodiments or of the related art are briefly introduced below. It is apparent that the drawings in the following description merely show some embodiments of the present application. For those of ordinary skill in the art, other drawings may be obtained based on these drawings without inventive efforts.

FIG. 1 is a schematic diagram of a data receiving flow of a network interface card device in the related art according to the present application;

FIG. 2 is a schematic diagram of a data transmitting flow of a network interface card device in the related art according to the present application;

FIG. 3 is a schematic diagram of a structural framework of a network interface card device in some implementations according to the present application;

FIG. 4 is a schematic diagram of a structural framework of a network interface card device in other implementations according to the present application;

FIG. 5 is a schematic diagram of accessing an extended memory by a host according to the present application;

FIG. 6 is a schematic flowchart of a network data transmission method according to the present application;

FIG. 7 is a schematic diagram of a structural framework of a network transmission system in some exemplary implementations according to the present application;

FIG. 8 is a schematic flowchart of receiving packet data based on FIG. 7 according to the present application;

FIG. 9 is a schematic flowchart of reading host data based on FIG. 7 according to the present application;

FIG. 10 is a schematic flowchart of sending packet data based on FIG. 7 according to the present application;

FIG. 11 is a schematic flowchart of issuing host data based on FIG. 7 according to the present application;

FIG. 12 is a structural diagram of a network data transmission apparatus in some implementations according to the present application;

FIG. 13 is a structural diagram of an electronic device in some implementations according to the present application; and

FIG. 14 is a structural diagram of a network data transmission system in other implementations according to the present application.

### DETAILED DESCRIPTION

To enable those skilled in the art to better understand the technical solutions of the present application, the present application will be further described in detail below with reference to the accompanying drawings and embodiments. The terms such as “first,” “second,” “third,” “fourth,” and the like in the description, the claims, and the accompanying drawings are used only to distinguish between different objects, and are not intended to denote any particular order. In addition, the terms “include” and “have”, as well as any variations thereof, are intended to cover a non-exclusive inclusion. The term “exemplary” means “serving as an example, embodiment, or illustration.” Any embodiment described herein as “exemplary” is not necessarily to be construed as preferred or advantageous over other embodiments.

It should be understood that a network interface card is computer hardware that enables a computer host to communicate over a computer network. A conventional network interface card is typically implemented as an expansion card inserted into a host bus. However, due to low cost of the network interface card and a widespread adoption of Ethernet standard, computer hosts may integrate a network interface on a motherboard currently. Such a motherboard may either integrate Ethernet functions directly into a processor, or connect a low-cost network interface card to the motherboard via a peripheral component interconnect express (PCI-Express, a high-speed serial computer expansion bus standard) bus.

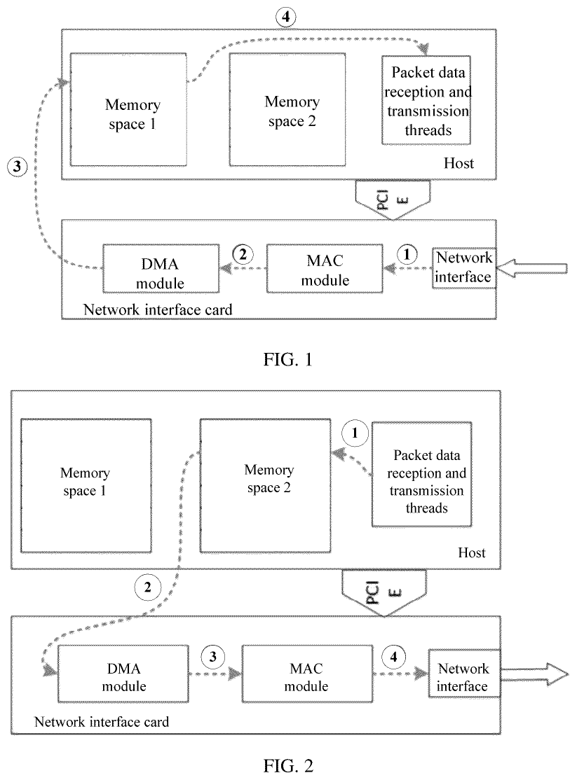

For a network transmission system in which the network interface card is connected to the host via the PCI-Express bus, the host performs initialization in advance: the host allocates two memory spaces in a local memory, i.e., memory space 1 and memory space 2. The two memory spaces are respectively configured to store received data packets and sent data packets. After the initialization is completed, the sending and reception of network data packets may be performed. A corresponding packet reception process is illustrated in FIG. 1, and includes: 1. a network interface card device receives network data via a network port and buffers the data in a Media Access Control (MAC) module; 2. the MAC module sends a data movement instruction to a Direct Memory Access (DMA) module to perform a data movement operation; 3. the DMA module moves the received packet data into the first memory space of the host, and then notifies packet data reception and transmission threads of the host to read corresponding data. The packet data reception and transmission threads may then acquire the corresponding packet data from the first memory space. The corresponding packet sending process is illustrated in FIG. 2, and includes: 1. the packet data reception and transmission threads store the sent packet data into the second memory space and send a data read instruction to the network interface card; 2. the DMA module of the network interface card acquires sent data from the second memory space of the host and stores the sent data into a buffer of the network interface card; 3. the MAC module acquires the sent data from the buffer and begins sending processing; and 4. the network port completes the sending processing of the data.

As may be seen from FIG. 1 and FIG. 2, in the related art, during both reception and sending of network data, the DMA module is employed to perform data movement operations. In the case of sending, data is moved from a host memory to a buffer of a network interface card, while in the case of reception, data is moved from the buffer of the network interface card to the host memory. In network transmission, for certain types of network data that do not require host processing, such as data with cyclic redundancy check (CRC) errors, it is unnecessary to move such data into the host memory; and such data may be processed and discarded directly at the network interface card. Similarly, certain packet data belongs to to-be-forwarded packets, which also do not need to be copied to the host memory, and may instead be processed directly within a memory of the network interface card. Furthermore, due to the inherent operating characteristics of the DMA module, it is more suitable for moving large volumes of data. However, when data packet is too short in length, the use of the DMA module for movement results in very low efficiency. Therefore, in the related art, the use of the network interface card for network data transmission suffers from low efficiency, which fails to meet actual user requirements.

In view of the above, the present application employs a programmable device and a memory expansion technology to implement the function of a high-performance network interface card. The host configures, by the memory expansion technology, a memory block in the programmable device as an extended memory accessible by the host. For network data that do not require host processing, or for which the movement efficiency via the DMA module is low, such data may be directly stored into the extended memory, without requiring all data to be stored into the host via the DMA module. In this way, the transmission efficiency of network data may be effectively enhanced. Having introduced the technical solutions of the present application, various non-limiting implementations of the present application will be described in details below. Numerous details are provided in the following detailed description for a better understanding of the present application. It should be understood by those skilled in the art that the present application may be practiced without these details. In other instances, well-known methods, means, components, and circuits are not described in detail so as not to obscure the essence of the present application.

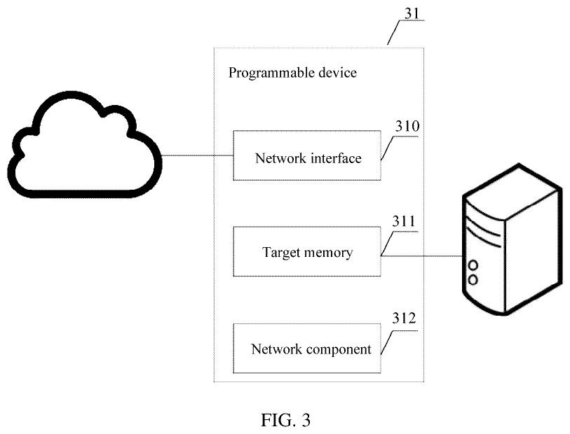

First, please refer to FIG. 3. FIG. 3 is a schematic diagram of a structural framework of a network interface card device in some implementations according to some embodiments of the present application. Some embodiments of the present application may include following content.

The network interface card device may include a programmable device 31. The programmable device 31 constructs a network platform based on a memory expansion method. The network platform constructed by the programmable device 31 may include a network interface 310, a target memory 311, and a network component 312.

In some embodiments of the present application, the programmable device 31 is connected to a network via the network interface 310. The network interface 310 may be compiled in advance and configured to implement sending and reception of network data, namely, to receive target network data sent from the network and to send to-be-sent network data of a host to the network. The process may include: data packets on the network are received through a physical layer interface (such as an Ethernet interface). The received data packets are demodulated and decoded at the physical layer and converted into digital signals. The digital signals are delivered to a receiving buffer. The data packets in the receiving buffer are transmitted to a data processing unit. The data packets are parsed by the data processing unit to extract information such as a destination address, a source address, and a protocol type. The data packets are delivered to a corresponding protocol processing unit based on the protocol type, such as a Transmission Control Protocol/Internet Protocol (TCP/IP) stack. The protocol processing unit performs protocol parsing and processing on the data packets, such as layered processing of the TCP/IP stack. The protocol processing unit performs processing on the data packets such as checksum verification, fragmentation and reassembly, error detection, and may implement advanced processing functions such as packet filtering and flow control. After protocol processing, the data packets are transmitted to a sending buffer. The data packets in the sending buffer are further transmitted to a sending data unit. The sending data unit converts the data packets into digital signals and sends the digital signals onto the network via the physical layer interface.

In some embodiments of the present application, the programmable device 31 is inserted into the host as the network interface card device. The host exchanges data with the programmable device 31 by the memory expansion method. During initialization of the programmable device 31, the host may configure, based on the memory expansion method, a target memory 311 of the programmable device 31 as an extended memory accessible by the host, such that the host may perform read and write access to the extended memory. The programmable device 31 may be any type of programmable device capable of processing large and complex transmissions, and the memory expansion method may be any memory expansion method provided by a memory expansion technology compatible with the programmable device 31 and the host. This does not affect the implementations of the present application. The network component 312 is a hardware set configured to receive and send data, and may adopt a data transmission mode that matches a data packet type of to-be-transmitted data. The to-be-transmitted data, in some embodiments of the present application, may be either target network data received from the network or data from the host intended to be sent to the network. The data packet type is determined based on a data type and a data length of the to-be-transmitted data. That is, different data types correspond to different transmission modes, and different data lengths also correspond to different transmission modes. In some embodiments of the present application, the “data transmission mode” refers to whether the data received from a data sending terminal is stored into a host memory or into the target memory (i.e., the extended memory) of the programmable device 31. Accordingly, there are two transmission modes: 1. storing the received data from the data sending terminal into the host memory; and 2. storing the received data from the data sending terminal into the extended memory of the programmable device 31. Whether the received data is stored in the host memory or the extended memory is determined by the data type and data length of the to-be-transmitted data. The data packet type may be predefined and assigned with a unique identifier for recognition. For ease of description, in some embodiments of the present application, the data packet type that corresponds to storing the received data from the data sending terminal into the extended memory of the programmable device 31 is defined as a network interface processed packet type. Such network interface processed packet type corresponds to data that either does not require host processing, or takes a long time to be moved to the host memory via the DMA module. Therefore, to enhance the efficiency of network data transmission, such data is directly stored in the extended memory, and the host may access and process the data in the extended memory.

From the above, it is evident that some embodiments of the present application achieve the function of a high-performance network interface card by employing the programmable device and the memory expansion technology. The host configures, by the memory expansion technology, a memory block in the programmable device as an extended memory accessible by the host, and the extended memory may be configured to store network data of predefined packet types, without requiring all network data to be stored into the host memory. For network data that does not require host processing, or for which movement via the DMA module is inefficient, such data may be stored directly into the extended memory. That is, the optimal data transmission method is determined based on the data packet type of the to-be-transmitted data, thereby effectively enhancing the efficiency of network data transmission.

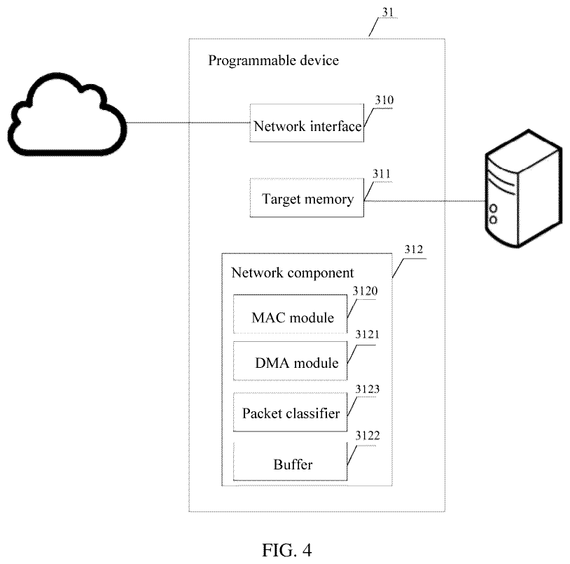

In the above-described embodiments, no particular limitation is imposed on the structure of the network component 312 of the programmable device 31. Some embodiments of the present application further provide some exemplary implementations, as shown in FIG. 4, which may include the following content.

The network component 312 may include a MAC module 3120, a DMA module 3121, a buffer 3122, and a packet classifier 3123. The MAC module 3120 is composed of a hardware controller and MAC communication protocol. The DMA module 3121 is configured to achieve high-efficient data transmission within a computer system without intervention of a central processing unit or data replication. The buffer 3122 is a buffer space within a programmable device 31, and the packet classifier 3123 is a device obtained by solidifying a computer program that implements data packet type identification and data distribution functions for to-be-transmitted data.

In some embodiments, the MAC module 3120 is configured to store target network data received over a network into the buffer 3122, and is further configured to send to-be-sent network data from the buffer 3122 to the network. The packet classifier 3123 is configured to identify a data packet type of the target network data and determine a corresponding storage location based on the data packet type of the target network data. The storage location includes either a host memory or a target memory. The packet classifier 3123 is further configured to store to-be-sent network data either read from the target memory or from the host memory via the DMA module 3121 into the buffer 3122 for transmission.

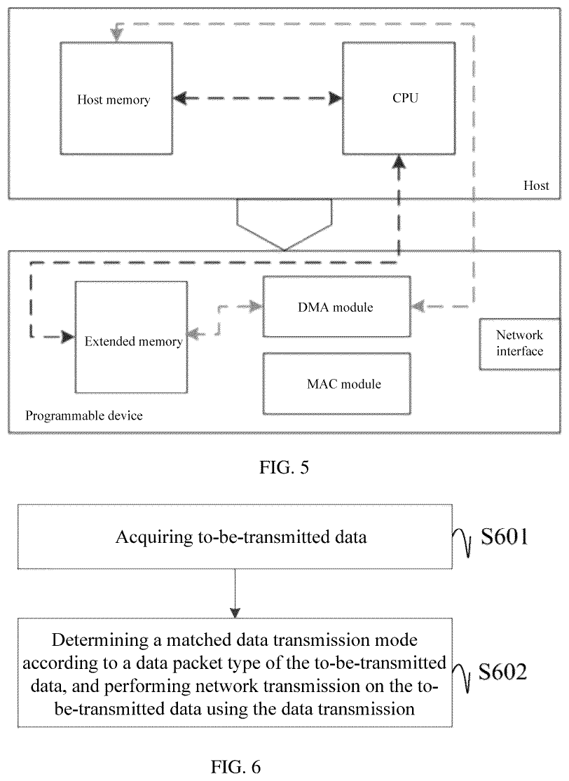

On this basis, the host may access an extended memory on the programmable device 31 by two methods, as shown in FIG. 5. The central processing unit of the host may access a target memory by a memory copy method. For example, the host may call a memory copy function, such as the mercy function (commonly used in C and C++), to access the extended memory. Exemplarily, for network interface card processed packet types that include data packet types having a data length smaller than a length threshold, the memory copy method may be implemented as follows: if to-be-transmitted data is target network data and a data length of the to-be-transmitted data is smaller than a length threshold, the network component stores the to-be-transmitted data into the target memory and sends a packet data read instruction to a host; and if the to-be-transmitted data is to-be-sent network data and the data length of the to-be-transmitted data is smaller than the length threshold, the host moves the data into the target memory by the memory copy method. The second method is to move data using a DMA module, i.e., to access the target memory by a DMA method. Exemplarily, the network component includes the DMA module, and the network interface card processed packet types exclude a data packet type having a data length greater than the length threshold. An implementation process of accessing the target memory by the DMA method may include: if the to-be-transmitted data is target network data and the data length is greater than the length threshold, the network component moves the data into the host memory via the DMA module; and if the to-be-transmitted data is the to-be-sent network data and a data length of the to-be-transmitted network data is greater than the length threshold, the host stores the to-be-transmitted data into the host memory and sends a packet data read instruction to the network component. Thus, the two access methods provided in some embodiments of the present application are applicable to data of different lengths: the memory copy method (e.g., using the memcpy function) achieves higher efficiency for short data, whereas the DMA method achieves higher efficiency for long data. Accordingly, the network component in some embodiments of the present application, through the combination of the MAC module, DMA module, buffer, and packet classifier, may achieve high-efficient transmission of both to-be-sent network data from the host and target network data from the network.

It may be understood that a Field-Programmable Gate Array (FPGA) may implement various logic functions through programming. Such flexibility and reconfigurability enable FPGA devices to be customized and optimized according to user requirements, and thus they are widely applied. A network interface card is required to process a large volume of data streams, including data packet reception, processing, and sending. An FPGA, with parallel processing capability, may achieve high-speed data processing and transmission by designing efficient data paths and parallel computing units. In other words, the FPGA is capable of providing the high-speed data processing capacity required for the network interface card. The FPGA may also be programmed and configured to implement various logic functions according to requirements. For the network interface card, data processing and transmission logic may be customized and optimized according to different network protocols and requirements, thereby improving performance and efficiency. Furthermore, FPGAs may support various interfaces and protocols, such as Ethernet and PCIe, through hardware design and programming, and by designing adapters and interface circuits, FPGAs may connect and communicate with computer systems and networks. Thus, the FPGA is capable of implementing the required interfaces and protocols for the network interface card. Based on the foregoing, in some exemplary implementations, the programmable device 31 may be implemented as an FPGA. In addition, Compute Express Link (CXL) provides high-bandwidth and low-latency connection, and may be configured to connect FPGAs with processors, accelerators, and memory devices. Accordingly, some embodiments of the present application may implement a network interface card function by combining an FPGA with CXL. In such embodiments, the programmable device 31 may further include a CXL module. The CXL module interconnects the FPGA with CXL, thereby enabling the host to extend a memory of the programmable device 31 and achieve a high-performance network interface card function, supporting high-speed data transmission and processing. The host may configure a target memory of the FPGA as an extended memory via CXL, i.e. the CXL module. For a data receiving process, i.e., when the to-be-transmitted data is the target network data, the FPGA identifies the data packet type of the to-be-transmitted data. If the to-be-transmitted data belongs to a predefined target data packet type and/or has a data length smaller than the length threshold, the FPGA stores the to-be-transmitted data into the target memory. For a data sending process, i.e., when the to-be-transmitted data is the to-be-sent network data of the host, the host identifies a data packet type of the to-be-transmitted data. If the to-be-transmitted data belongs to a predefined target packet type and/or has a data length smaller than the length threshold, the host stores the to-be-transmitted data directly into the target memory of the FPGA by the memory copy method. That is, the host stores the to-be-sent data which is sent to the network directly into the extended memory, instead of into a local memory of the host.

Furthermore, since CXL Type 3 devices are a group of memory modules, the CXL Type 3 devices provide persistent, volatile, or hybrid memory, and supporting both .io (input/output) and .mem (memory) protocols. The CXL.io protocol may be configured for device discovery, enumeration, error reporting, and management, while allowing devices to serve I/O-certain application purposes. In the CXL.mem protocol, a central processing unit of the host acts as a master device to send requests, while the device acts as a slave device to respond. Thus, the Type 3 devices may be employed as a memory expander for the host. Since there is no cache, the central processing unit of the host does not need to probe device caches and may use a simplified .mem protocol. Accordingly, the host may configure CXL in Type 3 mode to extend the memory.

From the above, it is evident that some embodiments of the present application utilize the flexibility and customizability of FPGA to enable programming and optimization according to requirements. By leveraging CXL to provide the compute express link technology and interface support provided by CXL, high-bandwidth and low-latency connection with other devices may be achieved. Accordingly, the combination of FPGA and CXL enables the implementations of high-performance network interface card functions.

In addition, based on the network interface card device provided in the foregoing embodiments, the present application further provides a process for implementing data sending and reception based on the network interface card device, i.e., a network data transmission mode. Please refer to FIG. 6, which illustrates a schematic flowchart of a network data transmission method according to some embodiments of the present application. Some embodiments may include the following content.
S601: Acquiring to-be-transmitted data

The to-be-transmitted data may be target network data received over a network, or to-be-sent network data of a host.
S602: Determining a matched data transmission mode according to a data packet type of the to-be-transmitted data, and performing network transmission on the to-be-transmitted data using the data transmission mode

In some embodiments of the present application, a data transmission mode corresponding to the to-be-transmitted data is determined based on the network interface card device described in the foregoing embodiment. The data transmission includes a data sending process and a data receiving process. If the to-be-transmitted data is target network data received over the network, the data transmission corresponds to a data receiving process, i.e., the target network data is stored to a position accessible by a host, which may be a host memory or a target memory of a programmable device, i.e., an extended memory of the host. If the to-be-transmitted data is to-be-sent network data from the host, the data transmission corresponds to a data sending process, i.e., the to-be-transmitted data is read from either the host memory or the extended memory, and sent to the network through a network interface of the network interface card device.

In the technical solutions provided in the present application, functions of a high-performance network interface card are implemented by means of a programmable device and a memory expansion technology. The host configures, by the memory expansion technology, a memory block in the programmable device as the extended memory accessible by the host. The extended memory may be configured to store network data of a pre-specified packet type, without the need to store all such network data in the host memory. Certain network data that does not require host processing and for which data movement through a DMA module is inefficient may be directly stored in the extended memory. That is, an optimal data transmission mode is determined according to the data packet type of the to-be-transmitted data, thereby effectively enhancing the transmission efficiency of network data.

In the foregoing embodiments, the detailed process of determining a matching data transmission mode based on the data packet type of the to-be-transmitted data is not specifically limited. The present application further provides some exemplary implementations, which may include the following content.

The packet data types of the to-be-transmitted data are defined as a network interface card processed packet type and a host processed packet type. The network interface card processed packet type refers to a data packet type that does not need to be stored in a host memory, while the host processed packet type refers to a data packet type that needs to be stored in the host memory.

Exemplarily, in order to further improve practicality, the network interface card processed packet type in some embodiments of the present application may include a preset data type and data having a length smaller than a length threshold; and other types are classified as host processed packet types. The process of identifying the packet data type of the to-be-transmitted data may include: if a data type of the to-be-transmitted data is a preset data type, determining that the data packet type of the to-be-transmitted data belongs to a network interface card processed packet type, where the preset data type is a data type that is not stored in the host memory; and if a data length of the to-be-transmitted data is smaller than a length threshold, determining that the data packet type of the to-be-transmitted data belongs to a network interface card processed packet type. Furthermore, the preset data types may be divided into two categories: a first category requiring subsequent operation processing; and a second category not requiring subsequent operation processing. The processor of the host processes these two categories as follows: if the to-be-transmitted data belongs to the first preset data type, the host reads the to-be-transmitted data and directly discards it. For example, the first preset data type may be Cyclic Redundancy Check (CRC) data; accordingly, if the to-be-transmitted data is CRC data, the host reads and discards the to-be-transmitted data; and if the to-be-transmitted data belongs to the second preset data type, the host reads and forwards the to-be-transmitted data. For example, the second preset data type may be to-be-forwarded packets; and accordingly, if the to-be-transmitted data is the to-be-forwarded packets, the host reads the to-be-transmitted data and forwards the to-be-transmitted data to a destination address. For network interface card processed packet types, if a data length of the to-be-transmitted data is smaller than the length threshold, the host invokes a memory copy function to copy the to-be-transmitted data to the host memory.

It may be seen from above that in certain embodiments of the present application, when a received packet has a CRC error, the packet is stored in the network interface card device, whereby there is no need to use the DMA module to move error data into the host memory. When a received packet is to-be-forwarded data, the packet is similarly stored at the network interface card device side to facilitate forwarding of such data. For short packets in both the sending and receiving processes, the host directly performs data movement operations without using the DMA module, thereby effectively enhancing transmission efficiency of network data.

With respect to the length threshold, in some embodiments of the present application, the length threshold may be preset based on prior knowledge or set to a default value such as 1 KB, and stored locally. When a user inputs a length threshold configuration instruction, the length threshold configuration instruction is parsed to obtain the length threshold, and then the length threshold is stored to a target location. However, this method is imprecise and not conducive to efficient transmission of network data.

In some embodiments of the present application, the length threshold may be determined through a convergence test. Test transmission data of different lengths is transmitted using both a memory copy method and a DMA method, and corresponding transmission times are collected. Comparative analysis is performed on transmission durations required for transmitting test transmission data of the same data length by the memory copy method and the DMA method, and a data length at which the transmission durations required by the memory copy method and the DMA method are equal is determined as a length threshold. For ease of description, the method in which the central processing unit of the host moves data from the extended memory to the host memory by calling a memory copy function is defined as the memory copy method, and the method in which data is moved from the buffer of the network interface card device to the host memory via the DMA module is defined as the DMA method. In the convergence test, when the data length of the test transmission data is equal to the length threshold, the time consumption of the DMA operation, i.e., the DMA method, is the same as that of the memory copy operation, i.e., the memory copy method. When the data length is greater than the length threshold, performing the data movement operation using the DMA method takes less time, whereas when the data length is smaller than the length threshold, performing the operation using the memory copy method takes less time. The testing process may include: setting the data length of the test transmission data to 1 KB, starting timing, and respectively moving the test transmission data based on the DMA method and the memory copy method. When the data movement is successfully completed, the timing ends. The transmission durations required by the two methods are then compared. If the DMA method takes longer time, the data length of the test transmission data needs to be increased; and if the memory copy method takes longer time, the data length of the test transmission data needs to be reduced. In this way, convergence test is performed to determine the data length at which the time consumed by the DMA method and the memory copy method is the same, and this data length is taken as the length threshold.

Thus, by determining the data movement operation method according to the length threshold, embodiments of the present application maximize transmission efficiency of network data.

For the data receiving process, i.e., when the to-be-transmitted data is target network data received over the network, the process of determining the corresponding data transmission mode according to the data packet type may include: the network interface card device receives target network data over the network and uses a packet classifier of the network interface card device to identify the data packet type. If the data packet type of the to-be-transmitted data belongs to the network interface card processed packet type, the to-be-transmitted data is stored in the target memory of the network interface card device, i.e., the extended memory of the host, and a packet data read instruction is sent to the host. If the data needs to be copied to the host memory, the host copies the data from the target memory to the host memory by the memory copy method, e.g., calling the copy function. If the data does not need to be copied, the host directly reads the corresponding data and performs corresponding operations according to the data type. If the data packet type of the to-be-transmitted data belongs to the host processed packet type, the network interface card device stores the to-be-transmitted data directly into the host memory via the DMA module.

For the data sending process, i.e., when the to-be-transmitted data is to-be-sent network data from the host to the network, the host identifies the data packet type of the to-be-transmitted data. If the data packet type belongs to the network interface card processed packet type, the to-be-transmitted data is stored into the target memory of the network interface card device, i.e., the extended memory of the host, and a packet data read instruction is sent to the packet classifier of the network interface card device. The packet classifier reads the to-be-transmitted data, and stores the to-be-transmitted data into a buffer, and the buffer sends the to-be-transmitted data through the MAC module and the network interface to the network. If the data packet type of the to-be-transmitted data belongs to the host processed packet type, the to-be-transmitted data is stored in the host memory, and a packet data read instruction is sent to the network interface card device. The packet classifier reads the to-be-transmitted data via the DMA module and stores the to-be-transmitted data into the buffer, and the buffer sends the to-be-transmitted data via the MAC module and the network interface to the network.

Accordingly, in some embodiments of the present application, during network data sending and receiving, whether the to-be-transmitted data is stored in the host memory or the extended memory of the host is determined according to the packet data type, thereby achieving maximum efficiency in data transmission.

Furthermore, to further enhance transmission efficiency of network data, according to the foregoing embodiments, before sending or receiving data packets, the host may perform initialization on the network interface card device. The initialization process may include: the host allocates a memory for a host packet receiving queue (for storing packets received by the host) and a host packet sending queue (for storing packets to be sent by the host). On the extended memory of the host, the host allocates a space for a network interface card packet receiving queue (for storing packets received by the network interface card device), and a network interface card packet sending queue (for storing packets to be sent by the network interface card device). The host may allocate a space for storing data index information on the extended memory.

Based on the above configuration, an exemplary method of determining the data transmission mode corresponding to to-be-transmitted data may include: pre-constructing storage data index information in the target memory of the network interface card device; updating the storage data index information based on the data packet type of the to-be-transmitted data; and determining the data transmission mode corresponding to the to-be-transmitted data based on the storage data index information and a sending terminal of the to-be-transmitted data. In some embodiments of the present application, the storage data index information records storage location information of received and sent packets, and exemplarily the storage location information may be represented by packet descriptors. The storage data index information may thus include a sending queue and a receiving queue. The sending queue records sent packet descriptors, and the receiving queue records received packet descriptors. The sending-terminal information specifies whether the to-be-transmitted data originates from the host or from the network, thereby determining whether the process is a sending or receiving process. In combination with the data storage location recorded in the storage data index information, it may then be determined whether the data is stored in the host memory or in the extended memory.

During the process of determining the data transmission mode corresponding to the to-be-transmitted data, the implementations for reading network data during reception may proceed as follows: pre-constructing a network interface card packet receiving queue in the target memory of the network interface card device and a host packet receiving queue in the host memory respectively; pre-pointing queue pointers of receiving producers corresponding to the network interface card packet receiving queue and the host packet receiving queue to corresponding initialization positions respectively, where the receiving producers include a buffer producer and a DMA module producer; and based on a receiving queue of the storage data index information, if the to-be-transmitted data belongs to the network interface card processed packet type, storing the to-be-transmitted data to a pointer position of the buffer producer in the network interface card packet receiving queue and moving a pointer of the buffer producer downward; if the to-be-transmitted data belongs to the host processed packet type, storing the to-be-transmitted data to a pointer position of the DMA module producer in the host packet receiving queue and moving a pointer of the DMA module producer downward. After the to-be-transmitted data is stored in the corresponding position, in order to facilitate data reading and storage, the movement trajectory may be recorded based on the pointer position to determine the next starting position. The process of reading the to-be-transmitted data by the host may include: pre-pointing queue pointers of receiving consumers corresponding to the network interface card packet receiving queue and the host packet receiving queue to corresponding initialization positions, where the receiving consumers are packet data reception and transmission threads of the host, and pointer positions of the receiving consumers are behind point positions of the receiving producers.

During the process of determining the data transmission mode corresponding to the to-be-transmitted data, the implementations for reading network data during sending may proceed as follows: if the to-be-transmitted data is to-be-sent network data, pre-constructing a network interface card packet sending queue in the target memory of the network interface card device and a host packet sending queue in the host memory respectively; pre-pointing queue pointers of sending producers corresponding to the network interface card packet receiving queue and the host packet receiving queue to corresponding initialization positions, where the sending producers are packet data reception and transmission threads of the host; pre-pointing queue pointers of the sending producers corresponding to a sending queue of the storage data index information to corresponding initialization positions, and moving pointer positions of the sending producers downward when updating the sending queue; and based on the sending queue of the storage data index information, if the to-be-transmitted data belongs to the network interface card processed packet type, storing the to-be-transmitted data into the network interface card packet receiving queue and moving a pointer of the sending producer downward; and if the to-be-transmitted data belongs to the host processed packet type, storing the to-be-transmitted data into the host packet receiving queue and moving the pointer of the sending producer downward. After the to-be-transmitted data is stored in the corresponding position, in order to facilitate data reading and storage, the movement trajectory may be recorded based on the pointer position so as to determine the next starting position. The process of reading the to-be-transmitted data by the network interface card device may include: pre-pointing queue pointers of sending consumers corresponding to the network interface card packet sending queue and the host packet sending queue to corresponding initialization positions, where the sending consumers are buffer consumers and DMA module consumers, and pointer positions of the sending consumers are behind pointer positions of the sending producers; and based on the sending queue of the storage data index information, if to-be-stored data belongs to the network interface card processed packet type, reading the to-be-stored data from the network interface card packet sending queue and moving a pointer of the buffer consumer downward; if the to-be-stored data belongs to the host processed packet type, reading the to-be-stored data from the host packet sending queue and moving a pointer of the DMA module consumer downward.

In order to make the technical solutions of the present application clearer to those skilled in the art, the present application further provides an exemplary embodiment, which may include the following content.

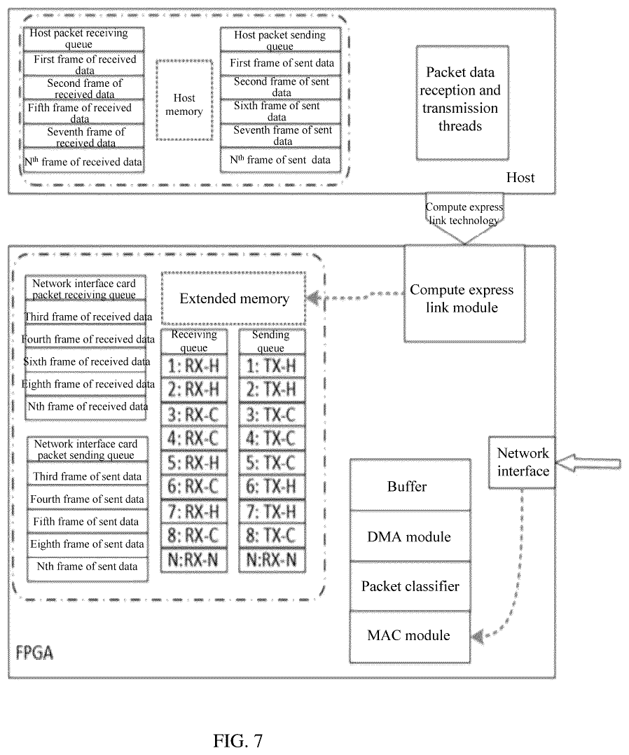

As shown in FIG. 7, in some embodiments of the present application, the network interface card device is implemented as FPGA+CXL. A network component of an FPGA includes a buffer, a DMA module, a packet classifier, and an MAC module. The host configures CXL in a TYPE3 mode to perform memory expansion, where a functional module for implementing the memory expansion is the CXL module. The host memory includes a host packet receiving queue and a host packet sending queue, while the extended memory of the host includes a network interface card packet receiving queue, a network interface card device packet sending queue, and storage data index information. The storage data index information includes a sending queue and a receiving queue. The host packet receiving queue, the host packet sending queue, the network interface card packet receiving queue, the network interface card sending packet, and the sending queue and receiving queue of the storage data index information are initialized, whereby each queue stores corresponding data in sequence. For example, the host packet receiving queue sequentially stores first frame of received data, second frame of received data, fifth frame of received data, seventh frame of received data, and N^{th} frame of received data. The host packet sending queue sequentially stores first frame of sent data, second frame of sent data, sixth frame of sent data, seventh frame of sent data, and N^{th} frame of sent data. The network interface card device packet receiving queue sequentially stores third frame of received data, fourth frame of received data, sixth frame of received data, eighth frame of received data, and N^{th} frame of received data. The network interface card device packet sending queue sequentially stores third frame of sent data, fourth frame of sent data, fifth frame of sent data, eighth frame of sent data, and N^{th} frame of sent data. The sending queue and the receiving queue respectively record the storage locations of the to-be-transmitted data. For example, in the receiving queue, the first frame of received data is stored in the host packet receiving queue, denoted as 1: RX-H; the second frame of received data is stored in the host packet receiving queue, denoted as 2: RX-H; the third frame of received data is stored in the network interface card packet receiving queue, denoted as 3: RX-C; the fourth frame of received data is stored in the network interface card packet receiving queue, denoted as 4: RX-C; the fifth frame of received data is stored in the host packet receiving queue, denoted as 5: RX-H; the sixth frame of received data is stored in the network interface card packet receiving queue, denoted as 6: RX-C; the seventh frame of received data is stored in the host packet receiving queue, denoted as 7: RX-H; the eighth frame of received data is stored in the network interface card packet receiving queue, denoted as 8: RX-C; and the N^{th} frame of received data may be stored in either the network interface card packet receiving queue or the host packet receiving queue, denoted as N:RX-N. In the sending queue, the first frame of sent data is stored in the host packet sending queue, denoted as 1: TX-H; the second frame of sent data is stored in the host packet sending queue, denoted as 2: TX-H; the third frame of sent data is stored in the network interface card packet sending queue, denoted as 3: TX-C; the fourth frame of sent data is stored in the network interface card packet sending queue, denoted as 4: TX-C; the fifth frame of sent data is stored in the network interface card packet sending queue, denoted as 5: TX-C; the sixth frame of sent data is stored in the host packet sending queue, denoted as 6: TX-H; the seventh frame of sent data is stored in the host packet sending queue, denoted as 7: TX-H; the eighth frame of sent data is stored in the network interface card packet sending queue, denoted as 8: TX-C; and the N^{th} frame of sent data may be stored in either the network interface card packet sending queue or the host packet sending queue, denoted as N:TX-N.

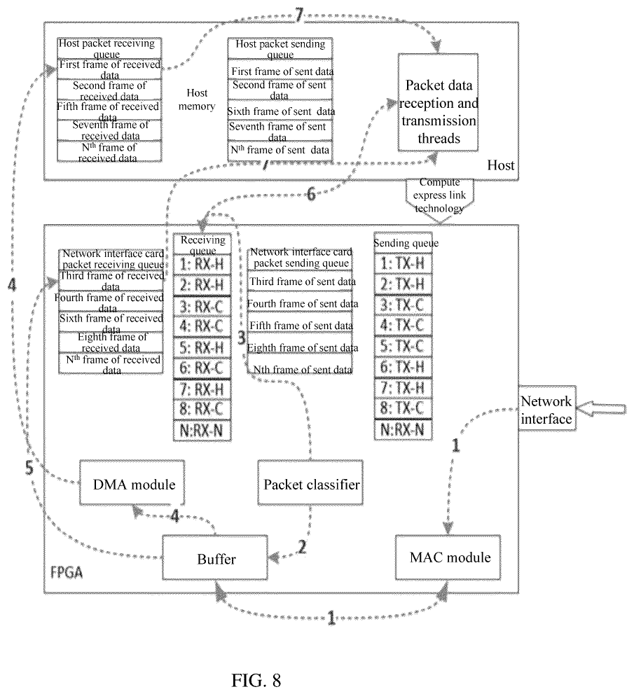

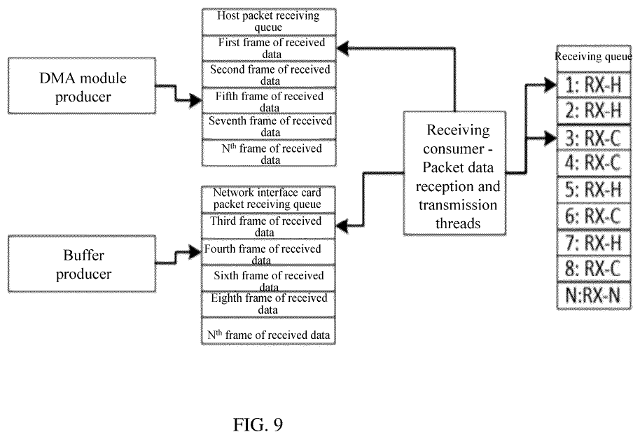

Based on the network data transmission system shown in FIG. 7, when the to-be-transmitted data is the target network data from the network, the packet data type of the to-be-transmitted data is first identified, and different packet data types are processed in a classified manner. The packet classifier queries a processing method corresponding to the data packet type as follows: if the to-be-transmitted data is CRC data, the packet is stored locally in the FPGA, and packet data reception and transmission threads of the host may directly discard the erroneous packet upon detection. If the to-be-transmitted data is a to-be-forwarded packet designated by the packet data reception and transmission threads of the host, the packet is stored locally in the FPGA, and the packet data reception and transmission threads of the host may directly forward the packet. If a data length of the to-be-transmitted data is smaller than a length threshold, the packet is stored locally in the FPGA, and the packet data reception and transmission threads perform data movement operation via a memory copy function. The packet data receiving process, as illustrated in FIG. 8, may include the following steps:
1. The MAC module stores the to-be-transmitted data into the buffer of the FPGA.
2. The packet classifier determines the packet data type of the to-be-transmitted data and labels a corresponding packet data type.
3. The packet classifier updates the receiving queue in the extended memory based on the packet data type of the to-be-transmitted data. For example, as shown in FIG. 7, packet 1 is stored in the host memory, packet 2 is stored in the host memory, and packet 3 is stored in a local memory.
4. The packet classifier uses the DMA module to store buffered to-be-transmitted data into the host packet receiving queue.
5. The packet classifier stores the buffered to-be-transmitted data into the network interface card packet receiving queue in the local extended memory and notifies the host to read the packet data.
6. The packet data reception and transmission threads of the host read a sending queue list in the extended memory of the network interface card device and locate the position of the corresponding queue where the target packet resides.
7. The host reads the packets from the host packet receiving queue in the local memory and also from the network interface card packet receiving queue in the extended memory of the network interface card device. The operation process of acquiring packets by the packet data reception and transmission threads of the host is illustrated in FIG. 9.

The packet data reception and transmission threads of the host initialize the receiving queue and point both the queue pointer and the queue pointer of the producer and the consumer to the initialization position of the receiving queue. The DMA module producer stores data at the pointer position of the DMA module producer, i.e., the host packet receiving queue, and moves the pointer of the DMA producer downward after storing. The buffer producer stores data at the pointer position of the buffer producer, i.e., the network interface card packet receiving queue, and moves the pointer of the buffer producer downward after storing. Upon receiving notification from the network interface card device, the packet data reception and transmission threads of the host, acting as the consumer, first read the packet location from the receiving queue in the extended memory. For example, if packet 1 exists in the host packet sending queue in the host memory, the packet data reception and transmission threads read the data from the host packet sending queue and move the pointer corresponding to the packet data reception and transmission threads serving as the consumer downward. The consumer pointer must always be behind the producer pointer, and once the end of the sending queue is reached, the pointer is looped back to the initial position.

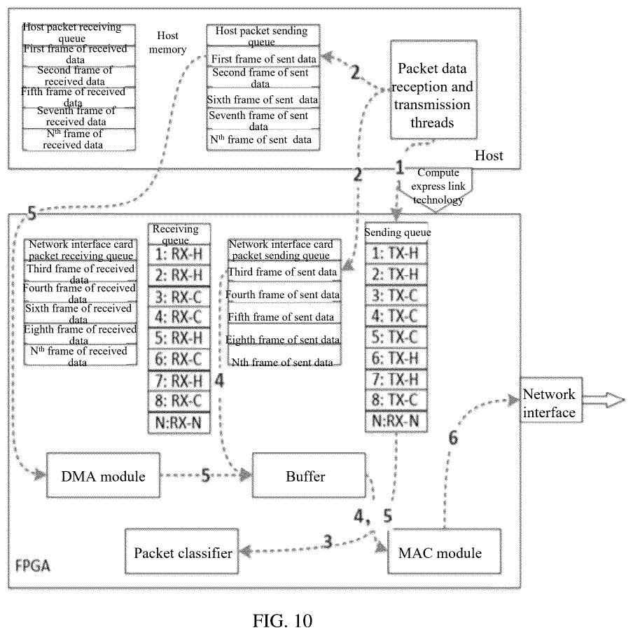

Based on the network data transmission system shown in FIG. 7, when the to-be-transmitted data is to-be-sent network data from the host, the packet data reception and transmission threads of the host classify the packet data type. If the data length of the to-be-transmitted data is greater than the length threshold, the to-be-transmitted data is stored in the host packet sending queue and subsequently moved using the DMA module. If the data length of the to-be-transmitted data is smaller than the length threshold, the packet is directly copied into the network interface card packet sending queue in the extended memory. The packet data sending process, as illustrated in FIG. 10, may include the following steps:
1. The packet data reception and transmission threads of the host classify the to-be-sent packet data and update the sending queue in the extended memory. For example, packet 1 is stored in the host packet sending queue in the host memory.
2. The classified packets are placed into the corresponding queues. Packets having a length greater than the length threshold are stored in the host packet sending queue, while packets having the length smaller than the threshold are copied by the packet data reception and transmission threads of the host into the network interface card packet sending queue in the extended memory.
3. The host notifies the packet classifier to acquire the to-be-sent data packets. The packet classifier reads the sending queue and locates the corresponding packet based on the pointer of the sending queue.
4. The packet classifier stores the packets from the network interface packet sending queue into the buffer in preparation for subsequent sending.
5. The packet classifier uses the DMA module to move packets from the host packet sending queue into the buffer in preparation for subsequent sending.
6. The packets in the buffer are sent.

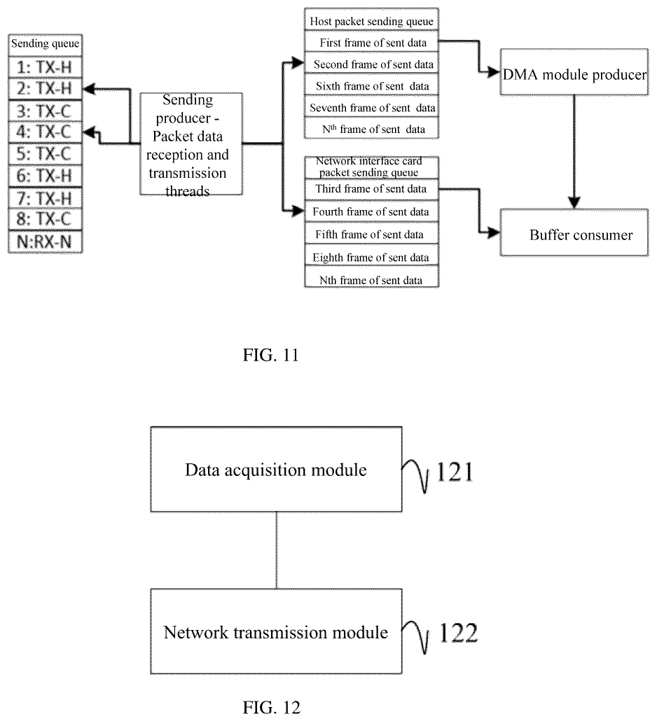

The operation process of sending packets by the packet data reception and transmission threads of the host is illustrated in FIG. 11. The packet data reception and transmission threads of the host initialize the receiving queue and point both the queue pointer of the producer and the queue pointer of the consumer to the initialization position of the sending queue. The packet data reception and transmission threads of the host, acting as the producer, write the packet location information into the sending queue in the extended memory and move the producer pointer downward. Different types of packets are stored into the corresponding host packet sending queues or network interface card packet sending queue, and the respective producer pointers are moved downward. The DMA module, acting as the consumer, is notified to move the packet data into the buffer and move the consumer pointer downward. The host may also directly store the packet data into the buffer, in which case the buffer consumer pointer is moved downward accordingly.

From the above, it may be seen that in some embodiments of the present application, the host expands its memory via CXL and creates network interface card packet sending queues and network interface card packet receiving queues for storing packet data. Sending queues and receiving queues are created in the extended memory as index information, whereby the packet sending/receiving program may locate the position of the corresponding packet data. Based on the length threshold for DMA data movement between the host and the FPGA determined by testing in different device environments, packets having the length greater than the threshold are moved via DMA, while packets having the length smaller than the threshold are copied by the host, thereby further enhancing the efficiency of network data storage. During the packet receiving process in the FPGA, the packet classifier stores packets with CRC errors, to-be-forwarded packets specified by the host, and packets having the length smaller than the length threshold into the extended memory of the FPGA. The packet data reception and transmission threads of the host may access these data packets directly through the extended memory, thereby enhancing network data processing efficiency. During the packet data sending process in the FPGA, the packet data reception and transmission threads of the host determine the packet storage location based on the packet length. Packets having the length than the threshold are stored in the host packet sending queue in the local memory, while packets having the length smaller than the threshold are directly copied into the network interface card packet sending queue in the extended memory, thereby effectively enhancing the overall efficiency of network data transmission.

The present application further provides a corresponding apparatus for the network data transmission method, which further enhances the practicality of the method. The apparatus may be described both in terms of functional modules and hardware implementation. The network data transmission apparatus provided in the present application will be described below. The apparatus is configured to implement the network data transmission method provided by the present application. In some embodiments of the present application, the network data transmission apparatus may include, or be divided into, one or more program modules. The one or more program modules are stored in a storage medium and executed by one or more processors to perform the network data transmission method disclosed in the embodiments. As referred to in some embodiments of the present application, a “program module” refers to a series of computer program instruction segments capable of accomplishing functions, and is more suitable than a program itself for describing the execution process of the network data transmission apparatus in the storage medium. The following description will introduce the functions of the program modules of some embodiments of the present application. The network data transmission apparatus described below may correspond to and be referenced with the network data transmission method described above.

From the perspective of functional modules, refer to FIG. 12. FIG. 12 is a structural diagram of a network data transmission apparatus in some implementations according to the present application. The apparatus may include:
a data acquisition module 121, configured to acquire to-be-transmitted data; and
a network transmission module 122, configured to determine a matched data transmission mode according to a data packet type of the to-be-transmitted data based on a network interface card device, and perform network transmission on the to-be-transmitted data using the data transmission mode.

In some embodiments of the present application, the network transmission module 122 may be configured to:
if the to-be-transmitted data is target network data sent over a network, cause a network interface card device to identify the data packet type of the to-be-transmitted data, and if the to-be-transmitted data belongs to a network interface card processed packet type, store the to-be-transmitted data into the target memory of the network interface card device and send a packet data read instruction to a host, whereby the host accesses the target memory by a memory copy method; or if the to-be-transmitted data belongs to a host processed packet type, store the to-be-transmitted data into the memory host through a DMA module, whereby the host accesses the target memory by a DMA method.

In some embodiments of the present application, the network transmission module 122 may be further configured to:
if a data type of the to-be-transmitted data is a preset data type, determine that the data packet type of the to-be-transmitted data belongs to a network interface card processed packet type, where the preset data type is a data type that is not stored in the host memory; or
if a data length of the data to-be-transmitted data is smaller than a length threshold, determine that the data packet type of the to-be-transmitted data belongs to the network interface card processed packet type.

In some embodiments of the present application, the network transmission module 122 may be further configured to:
if the to-be-transmitted data belongs to a first preset data type, allow the host to read the to-be-transmitted data and directly discard the to-be-transmitted data;
if the to-be-transmitted data belongs to a second preset data type, allow the host to read the to-be-transmitted data and forward the to-be-transmitted data; or
if a data length of the to-be-transmitted data is smaller than a length threshold, allow the host to call a memory copy function to copy the to-be-transmitted data into the host memory.

In some embodiments of the present application, the network transmission module 122 may be further configured to:
if the to-be-transmitted data is cyclic redundancy check data, allow the host to read the to-be-transmitted data and directly discard the to-be-transmitted data; or
if the to-be-transmitted data is a to-be-forwarded packet, allow the host to read the to-be-transmitted data and forward the to-be-transmitted data to a target address.

In some embodiments of the present application, the network transmission module 122 may be further configured to:
transmit test transmission data of different data lengths by a memory copy method and a DMA method respectively, and collect corresponding transmission times; and
perform comparative analysis on transmission durations required for transmitting test transmission data of the same data length by the memory copy method and the direct memory access method, and determine a data length at which the transmission durations required by the memory copy method and the direct memory access method are equal as a length threshold.

In some embodiments of the present application, the network transmission module 122 may be further configured to:
when receiving a length threshold configuration instruction input by a user, parse the length threshold configuration instruction to obtain a length threshold, and store the length threshold to a target location.

In some embodiments of the present application, the network transmission module 122 may be further configured to:
if the to-be-transmitted data is to-be-sent network data of a host, allow the host to identify the data packet type of the to-be-transmitted data;
if the data packet type of the to-be-transmitted data belongs to a network interface card processed packet type, store the to-be-transmitted data into a target memory of the network interface card device by a memory copy method and send a packet data read instruction to the network interface card device; or
if the data packet type of the to-be-transmitted data belongs to a host processed packet type, store the to-be-transmitted data into the host memory and send a packet data read instruction to the network interface card device to allow reading of corresponding data by a direct memory access method.

In some embodiments of the present application, the network transmission module 122 may be further configured to:
pre-construct storage data index information in the target memory of the network interface card device, where the storage data index information is configured to record storage location information of received packets and sent packets;
update the storage data index information based on the data packet type of the to-be-transmitted data; and
determine the data transmission mode corresponding to the to-be-transmitted data according to the storage data index information and sending-terminal information of the to-be-transmitted data.

In some embodiments of the present application, the network transmission module 122 may be further configured to:
pre-construct a network interface card packet receiving queue in the target memory of the network interface card device and a host packet receiving queue in the host memory respectively;
pre-point queue pointers of receiving producers corresponding to the network interface card packet receiving queue and the host packet receiving queue to corresponding initialization positions respectively, where the receiving producers include a buffer producer and a DMA module producer; and
if the to-be-transmitted data is target network data, based on a receiving queue of the storage data index information, and if the to-be-transmitted data belongs to the network interface card processed packet type, store the to-be-transmitted data to a pointer position of the buffer producer in the network interface card packet receiving queue and move a pointer of the buffer producer downward; or if the to-be-transmitted data belongs to the host processed packet type, store the to-be-transmitted data to a pointer position of the direct memory access module producer in the host packet receiving queue and move a pointer of the direct memory access module producer downward.

In some embodiments of the present application, the network transmission module 122 may be further configured to:
pre-point queue pointers of receiving consumers corresponding to the network interface card packet receiving queue and the host packet receiving queue to corresponding initialization positions, where the receiving consumers are packet data reception and transmission threads of the host, and pointer positions of the receiving consumers are behind point positions of the receiving producers;
determine, by the host, a storage location of a storage queue corresponding to the to-be-transmitted data according to the receiving queue, read the to-be-transmitted data according to the storage location of the to-be-transmitted data, and move a pointer of the receiving consumer downward.

In some embodiments of the present application, the network transmission module 122 may be further configured to:
pre-construct a network interface card packet sending queue in the target memory of the network interface card device and a host packet sending queue in the host memory respectively;
pre-point queue pointers of sending producers corresponding to the network interface card packet receiving queue and the host packet receiving queue to corresponding initialization positions, where the sending producers are packet data reception and transmission threads of the host;
pre-point queue pointers of the sending producers corresponding to a sending queue of the storage data index information to corresponding initialization positions, and move pointer positions of the sending producers downward when updating the sending queue; and
based on the sending queue of the storage data index information, if the to-be-transmitted data belongs to the network interface card processed packet type, store the to-be-transmitted data into the network interface card packet receiving queue and move a pointer of the sending producer downward; or if the to-be-transmitted data belongs to the host processed packet type, store the to-be-transmitted data into the host packet receiving queue and move the pointer of the sending producer downward.

In some embodiments of the present application, the network transmission module 122 may be further configured to:
pre-point queue pointers of sending consumers corresponding to the network interface card packet sending queue and the host packet sending queue to corresponding initialization positions, where the sending consumers include a buffer consumer and a DMA module consumer, and pointer positions of the sending consumers are behind pointer positions of the sending producers; and
based on the sending queue of the storage data index information, if to-be-stored data belongs to the network interface card processed packet type, read the to-be-stored data from the network interface card packet sending queue and move a pointer of the buffer consumer downward; or if the to-be-stored data belongs to the host processed packet type, read the to-be-stored data from the host packet sending queue and move a pointer of the direct memory access module consumer downward.

The functions of the respective functional modules of the network data transmission apparatus in some embodiments of the present application may be implemented according to the methods in the above method embodiments, and the implementation process may refer to the relevant descriptions of the above method embodiments, which will not be repeated here.

From the above, it may be seen that embodiments of the present application may effectively enhance transmission efficiency of network data.

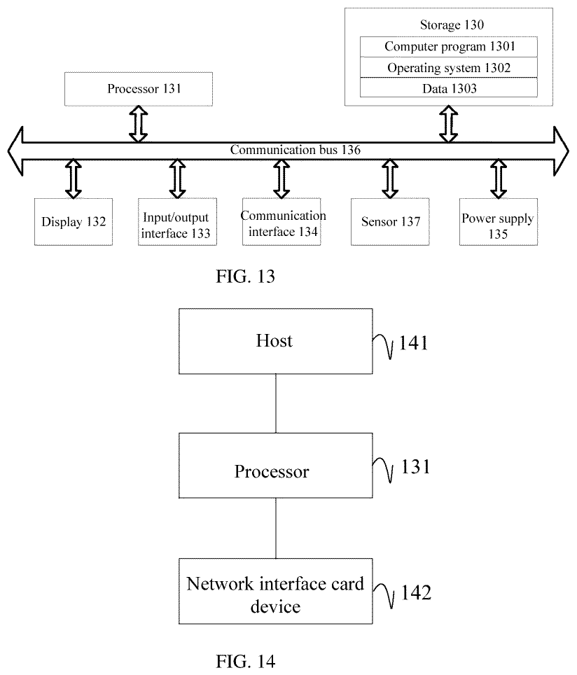

The above-described network data transmission apparatus is described from the perspective of functional modules. The present application also provides an electronic device described from a hardware perspective, as shown in FIG. 13. The electronic device includes a storage device 130 configured to store computer programs, and a processor 131 configured to implement, when executing the computer programs, the steps of the network data transmission method according to any of the foregoing embodiments. In some embodiments, the electronic device may further include a display 132, an input and output interface 133, a communication interface 134, a power supply 135, a communication bus 136, and sensors 137 for implementing various functions.

The processor 131 may include one or more processing cores, and may be a controller, a microcontroller, a microprocessor, or an artificial intelligence processor for processing computing operations related to machine learning. The storage device 130 may include one or more non-volatile readable storage media, high-speed random access memory, and non-volatile memory, and may be an internal storage unit or an external storage device. The storage device 130 may store application software installed on the electronic device and various data, such as codes of programs executed during the implementations of the network data transmission method, and may also temporarily store data that has been output or is to be output. In some embodiments of the present application, the storage device 130 is at least configured to store a computer program 1301, which, after being loaded and executed by the processor 131, implements the relevant steps of the network data transmission method disclosed in any of the foregoing embodiments. The resources stored therein may further include an operating system 1302 and data 1303, where the operating system 1302 may include Windows, Unix, Linux, etc. The data 1303 may include, but is not limited to, data corresponding to results of network data transmission.

It is understood that if the network data transmission method in the above embodiments is implemented in the form of software functional units and sold or used as an independent product, it may be stored in a non-volatile computer-readable storage medium. Based on such an understanding, the technical solutions of the application substantially or parts making contributions to the related art or part of the technical solutions may be embodied in form of software product, and the computer software product is stored in a storage medium, to execute all or part of the steps of the method in each embodiment of the application. Accordingly, the present application further provides a non-volatile readable storage medium having a computer program stored therein. The computer program, when executed by a processor, performs the steps of the network data transmission method according to any of the foregoing embodiments.

The present application further provides a network data transmission system. Referring to FIG. 14, FIG. 14 is a schematic diagram of a structural framework of a network data transmission system in some exemplary implementations, which may include the following content:

In some embodiments of the present application, the network data transmission system may include a host 141, a network interface card device 142, and a processor 131. The host 141 may be any medium or small-sized single server, a server in a data center, or a personal computer capable of being externally connected to a network interface card device. The network interface card device 142 may be any network interface card device as described in the foregoing embodiments, and the processor 131 may be configured to, when executing the computer program stored in the storage device, implement the steps of the network data transmission method as described in any embodiment.

The functions of the respective functional modules of the network data transmission system in embodiments of the present application may be implemented according to the methods in the above method embodiments, and the implementation process may refer to the relevant descriptions of the above method embodiments, which will not be repeated here.

As may be seen from the above, in some embodiments of the present application, by deploying the above-described network interface card device for the host, the transmission efficiency of network data of the host may be effectively enhanced.

The above provides a detailed description of the network interface card device, the network data transmission method, apparatus, and system, electronic device, and non-volatile readable storage medium according to the present application. Various modifications and variations may be made to the present application without departing from the principles of the present application, and such modifications and variations also fall within the scope of protection of the claims of the present application.

1. A network interface card device, comprising a programmable device, the programmable device constructing a network platform based on a memory expansion method, the network platform comprising a network interface, a target memory, and a network component;
the programmable device being connected to a network via the network interface and exchanging data with a host by the memory expansion method; the host, based on the memory expansion method, configuring the target memory of the programmable device as an extended memory of the host; and the network component transmitting data using a data transmission mode that matches a data packet type of to-be-transmitted data; wherein
the to-be-transmitted data is target network data received or to-be-sent network data of the host; the data packet type is determined based on a data type and a data length of the to-be-transmitted data; and the extended memory is configured to store the to-be-transmitted data that belongs to a network interface card processed packet type.

2. The network interface card device according to claim 1, wherein the network component comprises a media access control module, a direct memory access module, a buffer, and a packet classifier, wherein
the media access control module is configured to store the target network data received over the network into the buffer and is further configured to send the to-be-sent network data in the buffer over the network; and
the packet classifier is configured to identify a first data packet type of the target network data and determine a corresponding storage location based on the first data packet type of the target network data, and is further configured to store the to-be-sent network data, which is read from the target memory or from a host memory via the direct memory access module, into the buffer, the corresponding storage location comprising the host memory and the target memory.

3. The network interface card device according to claim 1, wherein a central processing unit of the host accesses the target memory by a memory copy method; and the network interface card processed packet type comprises a data packet type having a data length smaller than a length threshold;
when the to-be-transmitted data is the target network data and the data length of the to-be-transmitted data is smaller than the length threshold, the network component stores the to-be-transmitted data into the target memory and sends a packet data read instruction to the host; and
when the to-be-transmitted data is the to-be-sent network data and the data length of the to-be-transmitted data is smaller than the length threshold, the host moves the to-be-transmitted data into the target memory by the memory copy method.

4. The network interface card device according to claim 1, wherein the network component comprises a direct memory access module, and a central processing unit of the host accesses the target memory by a direct memory access method; and the network interface card processed packet type excludes a data packet type having a data length greater than a length threshold;
when the to-be-transmitted data is the target network data and the data length of the to-be-transmitted data is greater than the length threshold, the network component moves the to-be-transmitted data into a host memory by the direct memory access module; and
when the to-be-transmitted data is the to-be-sent network data and the data length of the to-be-transmitted data is greater than the length threshold, the host stores the to-be-transmitted data into the host memory and sends a packet data read instruction to the network component.

5. The network interface card device according to claim 1, wherein the programmable device is a field-programmable gate array and constructs the network platform based on a compute express link technology;
the host configures a first target memory of the field-programmable gate array as the extended memory by the compute express link technology;
when the to-be-transmitted data is the target network data, the field-programmable gate array identifies the data packet type of the to-be-transmitted data, and when at least one of the to-be-transmitted data belongs to a target preset data type or the data length of the to-be-transmitted data is smaller than a length threshold, the to-be-transmitted data is stored into the first target memory; and when the to-be-transmitted data is the to-be-sent network data, the host identifies the data packet type of the to-be-transmitted data, and
when at least one of the to-be-transmitted data belongs to the target preset data type or the data length of the to-be-transmitted data is smaller than the length threshold, the to-be-transmitted data is stored into the first target memory of the field-programmable gate array by a memory copy method.

6. A network data transmission method, comprising:
acquiring to-be-transmitted data; and
based on a network interface card device, determining a data transmission mode matched according to a data packet type of the to-be-transmitted data, and performing network transmission on the to-be-transmitted data using the data transmission mode; wherein
the network interface card device comprises a programmable device, the programmable device constructing a network platform based on a memory expansion method, the network platform comprising a network interface, a target memory, and a network component;
the programmable device being connected to a network via the network interface and exchanging data with a host by the memory expansion method; the host, based on the memory expansion method, configuring the target memory of the programmable device as an extended memory of the host; and the network component transmitting data using the data transmission mode that matches the data packet type of the to-be-transmitted data; wherein
the to-be-transmitted data is target network data received or to-be-sent network data of the host; the data packet type is determined based on a data type and a data length of the to-be-transmitted data; and the extended memory is configured to store the to-be-transmitted data that belongs to a network interface card processed packet type.

7. The network data transmission method according to claim 6, wherein the to-be-transmitted data is the target network data received over a network, and the network interface card device identifies the data packet type of the to-be-transmitted data; and the determining a data transmission mode matched according to a data packet type of the to-be-transmitted data comprises:
when the data packet type of the to-be-transmitted data belongs to the network interface card processed packet type, storing the to-be-transmitted data into the target memory of the network interface card device and sending a packet data read instruction to a host; and
when the data packet type of the to-be-transmitted data belongs to a host processed packet type, storing the to-be-transmitted data into a host memory through a direct memory access module.

8. The network data transmission method according to claim 7, wherein the determining a data transmission mode matched according to a data packet type of the to-be-transmitted data comprises:
when a data type of the to-be-transmitted data is a preset data type, determining that the data packet type of the to-be-transmitted data belongs to the network interface card processed packet type, wherein the preset data type is a data type that is not stored into the host memory; and
when the data length of the to-be-transmitted data is smaller than a length threshold, determining that the data packet type of the to-be-transmitted data belongs to the network interface card processed packet type.

9. The network data transmission method according to claim 8, wherein the host accesses the target memory by a memory copy method, comprising:
when the to-be-transmitted data belongs to a first preset data type, the host reads the to-be-transmitted data and directly discards the to-be-transmitted data;
when the to-be-transmitted data belongs to a second preset data type, the host reads the to-be-transmitted data and forwards the to-be-transmitted data; and
when the data length of the to-be-transmitted data is smaller than the length threshold, the host calls a memory copy function to copy the to-be-transmitted data into the host memory, to access the target memory by the memory copy method.

10. The network data transmission method according to claim 9, wherein the host accesses the target memory by the memory copy method, comprising:
when the to-be-transmitted data is cyclic redundancy check code data, the host reads the to-be-transmitted data and directly discards the to-be-transmitted data; and
when the to-be-transmitted data is a to-be-forwarded packet, the host reads the to-be-transmitted data and forwards the to-be-transmitted data to a target address.

11. The network data transmission method according to claim 6, wherein before the determining a data transmission mode matched according to a data packet type of the to-be-transmitted data, the method further comprises:
transmitting test transmission data of different data lengths by a memory copy method and a direct memory access method respectively, and collecting corresponding transmission times; and
performing comparative analysis on transmission times required for transmitting test transmission data of a same data length by the memory copy method and the direct memory access method, and determining a data length at which the transmission time required by the memory copy method and the transmission time required by the direct memory access method are equal as a length threshold.

12. The network data transmission method according to claim 6, wherein before the determining a data transmission mode matched according to a data packet type of the to-be-transmitted data, the method further comprises:
when receiving a length threshold configuration instruction input by a user, parsing the length threshold configuration instruction to obtain a length threshold, and storing the length threshold to a target location.

13. The network data transmission method according to claim 6, wherein the to-be-transmitted data is the to-be-sent network data of the host, and the host identifies the data packet type of the to-be-transmitted data; and the determining a data transmission mode matched according to a data packet type of the to-be-transmitted data comprises:
when the data packet type of the to-be-transmitted data belongs to the network interface card processed packet type, storing the to-be-transmitted data into the target memory of the network interface card device and sending a packet data read instruction to the network interface card device; and
when the data packet type of the to-be-transmitted data belongs to a host processed packet type, storing the to-be-transmitted data into a host memory and sending the packet data read instruction to the network interface card device.

14. The network data transmission method according to claim 6, wherein the determining a data transmission mode matched according to a data packet type of the to-be-transmitted data comprises:
pre-constructing storage data index information in the target memory of the network interface card device, the storage data index information being configured to record storage location information of received packets and sent packets;
updating the storage data index information based on the data packet type of the to-be-transmitted data; and
determining the data transmission mode corresponding to the to-be-transmitted data according to the storage data index information and sending-terminal information of the to-be-transmitted data.

15. The network data transmission method according to claim 14, wherein the to-be-transmitted data is the target network data, and the determining the data transmission mode corresponding to the to-be-transmitted data according to the storage data index information and sending-terminal information of the to-be-transmitted data comprises:
pre-constructing a network interface card packet receiving queue in the target memory of the network interface card device and a host packet receiving queue in a host memory respectively;
pre-pointing queue pointers of receiving producers corresponding to the network interface card packet receiving queue and the host packet receiving queue to corresponding initialization positions respectively, the receiving producers comprising a buffer producer and a direct memory access module producer; and
based on a receiving queue of the storage data index information, when if the to-be-transmitted data belongs to the network interface card processed packet type, storing the to-be-transmitted data to a pointer position of the buffer producer in the network interface card packet receiving queue and moving a pointer of the buffer producer downward; and when if the to-be-transmitted data belongs to a host processed packet type, storing the to-be-transmitted data to a pointer position of the direct memory access module producer in the host packet receiving queue and moving a pointer of the direct memory access module producer downward.

16. The network data transmission method according to claim 15, wherein after the performing network transmission on the to-be-transmitted data using the data transmission mode, the method further comprises:
pre-pointing queue pointers of receiving consumers corresponding to the network interface card packet receiving queue and the host packet receiving queue to corresponding initialization positions respectively, the receiving consumers being packet data reception and transmission threads of the host, and pointer positions of the receiving consumers being smaller than pointer positions of the receiving producers; and
determining, by the host, a storage position of a storage queue corresponding to the to-be-transmitted data according to the receiving queue, reading the to-be-transmitted data according to the storage position of the to-be-transmitted data, and moving a pointer of the receiving consumer downward.

17. The network data transmission method according to claim 14, wherein the to-be-transmitted data is the to-be-sent network data, and the determining the data transmission mode corresponding to the to-be-transmitted data according to the storage data index information and sending-terminal information of the to-be-transmitted data comprises:
pre-constructing a network interface card packet sending queue in the target memory of the network interface card device and a host packet sending queue in the host memory respectively;
pre-pointing queue pointers of sending producers corresponding to the network interface card packet sending queue and the host packet sending queue to corresponding initialization positions respectively, the sending producers being packet data reception and transmission threads of the host;
pre-pointing queue pointers of the sending producers corresponding to a sending queue of the storage data index information to corresponding initialization positions, and moving pointer positions of the sending producers downward when updating the sending queue; and
based on the sending queue of the storage data index information, when the to-be-transmitted data belongs to the network interface card processed packet type, storing the to-be-transmitted data into the network interface card packet sending queue and moving a pointer of the sending producer downward; and when the to-be-transmitted data belongs to the host processed packet type, storing the to-be-transmitted data into the host packet sending queue and moving the pointer of the sending producer downward.

18. The network data transmission method according to claim 17, wherein after the performing network transmission on the to-be-transmitted data using the data transmission mode, the method further comprises:
pre-pointing queue pointers of sending consumers corresponding to the network interface card packet sending queue and the host packet sending queue to corresponding initialization positions, wherein the sending consumers comprise a buffer consumer and a direct memory access module consumer, and pointer positions of the sending consumers are smaller than the pointer positions of the sending producers; and
based on the sending queue of the storage data index information, when the to-be-transmitted data belongs to the network interface card processed packet type, reading the to-be-transmitted data from the network interface card packet sending queue and moving a pointer of the buffer consumer downward; and when the to-be-transmitted data belongs to the host processed packet type, reading the to-be-transmitted data from the host packet sending queue and moving a pointer of the direct memory access module consumer downward.

19.-20. (canceled)

21. A non-volatile readable storage medium, wherein the non-volatile readable storage medium has a computer program stored therein, and the computer program, when executed by a processor, implements steps of a network data transmission method comprising:
acquiring to-be-transmitted data; and
based on a network interface card device, determining a data transmission mode matched according to a data packet type of the to-be-transmitted data, and performing network transmission on the to-be-transmitted data using the data transmission mode; wherein
the network interface card device comprises a programmable device, the programmable device constructing a network platform based on a memory expansion method, the network platform comprising a network interface, a target memory, and a network component;
the programmable device being connected to a network via the network interface and exchanging data with a host by the memory expansion method; the host, based on the memory expansion method, configuring the target memory of the programmable device as an extended memory of the host; and the network component transmitting data using the data transmission mode that matches the data packet type of the to-be-transmitted data; wherein
the to-be-transmitted data is target network data received or to-be-sent network data of the host; the data packet type is determined based on a data type and a data length of the to-be-transmitted data; and the extended memory is configured to store the to-be-transmitted data that belongs to a network interface card processed packet type.

22. (canceled)

23. The network interface card device according to claim 1, wherein the memory expansion method is any memory expansion method provided by a memory expansion technology compatible with the programmable device and the host.
